(19) United States
(12) Patent Application Publication
(10) Pub. No.: US 2009/0074955 A1
(43) Pub. Date: Mar. 19, 2009

(54) METHODS FOR PATTERNING ELECTRONIC ELEMENTS AND FABRICATING MOLDS

(76) Inventor: Harry D. Rowland, East Peoria, IL (US)

Correspondence Address: Patent Docket Department;Armstrong Teasdale LLP, One Metropolitan Square, Suite 2600, St. Louis, MO, 63102-2740, US

(21) Appl. No.: 12/212,330

(22) Filed: Sep. 17, 2008

Related U.S. Application Data
(60) Provisional application No. 60/994,218, filed on Sep. 17, 2007.

(51) Int. Cl. B32B 3/10; B05D 5/00

(52) U.S. Cl. 427/97.3; 427/264; 427/155

(57) ABSTRACT

A method for patterning a surface includes providing a first layer of mechanically deformable material having a first surface. A second layer of mechanically deformable material is placed on the first surface. At least a portion of the second layer is controllably displaced to form at least one patterned void through the second layer.

### CROSS REFERENCE TO RELATED APPLICATIONS

This application claims the benefit of U.S. Provisional Application No. 60/994,218, filed Sep. 17, 2007, which is hereby incorporated by reference in its entirety.

### BACKGROUND OF THE INVENTION

The subject matter described herein relates generally to fabrication of electronic, chemical, and mechanical devices and, more particularly, to fabrication of electronic, chemical, and mechanical devices by deposition techniques, such as printing through mask structures patterned by multiple layer embossing.

Electronic and electromechanical components are conventionally fabricated in expensive manufacturing facilities focused on surface machining of silicon and other materials compatible with complementary metal-oxide semiconductor (CMOS) circuits. The resulting manufacturing relies on complex multi-step processing with escalating costs and throughput time for feature sizes less than about 1 micron (μm) that may inhibit small to medium volume production of microelectromechanical systems (MEMS) components and microsystem prototypes. In addition to the associated expense, the conventional fabrication processes ordinarily employed to create electronic and electromechanical components involve high temperatures, which limit the ability to manufacture these components using heat-sensitive materials, such as conventional flexible plastic substrates and organic and biological molecules.

New techniques and materials may decrease the cost of electronic and electromechanical components while utilizing low temperature manufacture processes, allowing for the fabrication of nanoscale electronic and electromechanical devices on a variety of substrates using selective deposition, printing and/or imaging technologies. These selective deposition, printing and/or imaging technologies may utilize nanoparticles or inks including nanoparticles to fabricate device layers and device structures. Because the nanoparticles exhibit significantly lower melting temperatures than bulk materials, a layer of metallic, semiconducting, or dielectric nanoparticles can be deposited on a substrate and annealed at relatively low temperatures, whereby the nanoparticles melt to form a continuous film.

Recent efforts to make electronic and electromechanical devices include printing processes and metal nanoparticle solutions. For example, nanoparticle printing and post-processing may be utilized to create metallic and semiconducting elements on a polymer substrate. However, the process is entirely additive and requires control of selective radiation to create patterns of conducting and insulating areas. Another conventional method creates patterns of functional areas on a surface without the need for control of selective radiation. However, this method requires a chemical mechanical polishing post-processing step. Yet another conventional method creates patterns of functional areas on a surface using non-selective radiation and etching, but this patterning process requires multiple post-processing etch steps.

FIGS. 1-6 are cross-sectional views illustrating a conventional process for forming a mask structure on a substrate surface using a patterned stamp surface. A stamp structure 100 displaces via an embossing or molding step a deformable medium 102 deposited or formed on a substrate 104. Stamp structure 100 has a three-dimensional topography having raised regions 106 and lowered regions 108. FIG. 2 shows displacement via embossing or molding of deformable medium 102 by stamp structure 100 to form a deformable medium surface having a three-dimensional topography. FIG. 3 shows stamp structure 100 released from deformable medium 102 after the embossing or molding step is completed, resulting in replication of the three-dimensional topography of stamp structure 100 in deformable medium 102. Lowered regions 110 in deformable medium 102 are formed by corresponding raised regions 106 of stamp structure 100. Raised regions 112 of deformable medium 102 are formed by corresponding lowered regions 108 of stamp structure 100. A thin residual layer 114 of deformable medium 102 remains after stamp structure 100 controllably displaces deformable medium 102, and partially defines lowered region 110. FIG. 4 shows deformable medium 102 with residual layer 114 removed during an additional processing step such that deformable medium 102 forms a mask structure 116 with unmasked areas 118 providing access to a surface of substrate 104. An additional layer of material 120 is deposited or coated on mask structure 116, as shown in FIG. 5. Material 120 can be processed chemically or via thermal or electromagnetic radiation such that material 120 is patterned on substrate 104 after mask structure 116 has been removed, as shown in FIG. 6. Mask structure 116 can be removed by a lift off process, for example.

One drawback to the conventional process shown in FIGS. 1-6 is the thin residual layer 114 remaining within lowered region 110 as a result of the embossing or molding step. This residual layer 114 must be removed to unmask and expose the substrate surface, often with plasma processing or chemical etch/dissolution steps that are difficult to control.

### BRIEF DESCRIPTION OF THE INVENTION

In one aspect, a method is provided for patterning a layer surface of a multi-layer structure. The method includes providing a first layer of mechanically deformable material having a first surface. A second layer of mechanically deformable material is placed on the first surface. At least a portion of the second layer is controllably displaced to form at least one patterned void through the second layer.

In another aspect, a method for making a mold structure having a controlled topography is provided. The method includes providing a first layer of polymeric material. A second layer of polymeric material is deposited on a first surface of the first layer. At least one of the first layer and the second layer is patterned to form a mask structure. The mask structure is attached to a third layer of material such that the second layer contacts the third layer. The first layer is removed such that the mask structure provides access to the third layer. A fourth layer of material is deposited on the mask structure and the second layer is removed such that the fourth layer has a surface having a controlled topography.

### BRIEF DESCRIPTION OF THE DRAWINGS

FIGS. 1-6 illustrate a conventional, prior art method for forming a mask structure on a substrate surface using a patterned stamp;

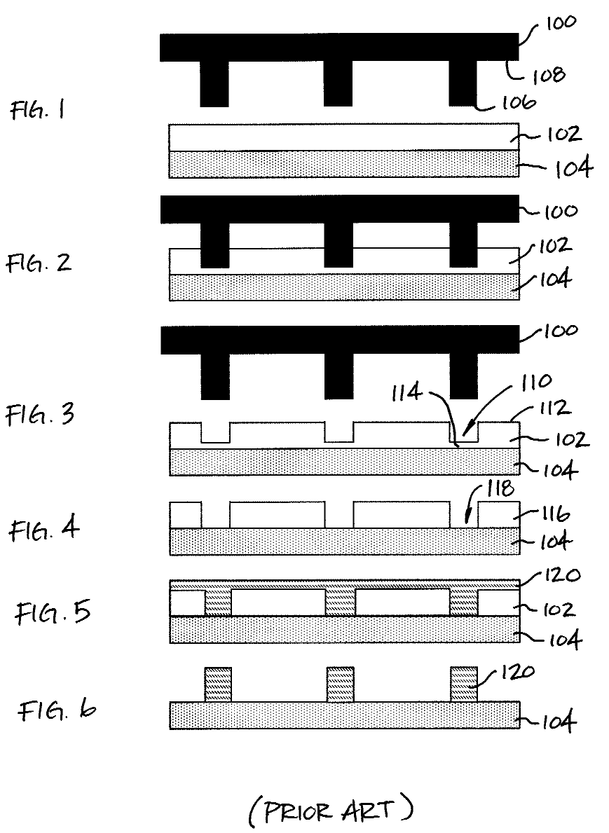

FIGS. 7-12 illustrate an exemplary method for forming a mask structure on a multi-layer structure including a mechanically deformable first layer and a mechanically deformable second layer using a patterned stamp;

FIGS. 13-20 illustrate an exemplary method for forming a mask structure on a multi-layer structure, deposition of a third layer of material, and patterning of the third layer via a lift off process;

FIGS. 21-26 illustrate an exemplary method for forming a mask structure on a multi-layer structure, and subsequent deposition and patterning of a third layer of material;

FIGS. 27-33 illustrate an exemplary method for forming a mask structure on a multi-layer structure, deposition of a third layer of material, and patterning of the third layer via a planarization process;

FIGS. 34-38 illustrate an exemplary method for forming a transistor using a multi-layer structure; and

FIGS. 39-46 illustrate an exemplary method for creating controlled topography on an arbitrary surface using a mask structure.

### DETAILED DESCRIPTION OF THE INVENTION

The embodiments described herein provide a patterning method that allows non-selective radiation and simple post-processing. Further, the patterning method is a production scalable method for cost-effective fabrication of high performance nanoscale electronic, chemical, and/or mechanical devices.

The embodiments described herein provide methods that utilize multi-layer embossing to create mask structures and printing deposition of nanoparticles to create functional systems. As used herein, references to a “mask” or “mask structure” should be understood to refer to a patterned layer that is used in a subsequent step to pattern a layer below the mask or the mask structure. The method exploits the precise nanometer resolution of forming via embossing to enable nanometer mask structure formation. The method further exploits the low melting temperatures of nanoparticles to enable patterning and forming of high resolution electronically functional features at low processing temperatures. As a result, the method may be utilized to mass produce nanoscale electronic, chemical, and/or mechanical devices on large area flexible substrates using non-vacuum processes.

Further, the methods as described herein may be used to pattern surfaces or multiple layers including a polymer, metal, bulk metallic glass, and/or any other suitable material. The patterned layer is formed by depositing a layer of a mechanically deformable second material onto a layer of a mechanically deformable first material. In one embodiment, the first material is a polymer, ceramic, metal, bulk metallic glass, or spin on glass and the second material is a polymer, curable polymer, or spin on glass. The polymer may be a low-porosity packaging material. In one embodiment, the layer of second material is deposited and/or coated onto a surface of the first layer with an average layer thickness of about 2.5 microns or less. In alternative embodiments, other structural, sacrificial, and/or chemically functional layers may be deposited above, below, and/or in between the first layer and the second layer. In further alternative embodiments, a substrate layer may support the first layer.

In one embodiment, the first layer includes a structural material of higher modulus or higher softening temperature than the second layer. The second material may include any suitable material including, without limitation, a curable polymer. After the second material is coated and/or deposited onto the first layer, the first layer and/or the second layer are controllably displaced by embossing or molding. In one embodiment, the second layer is first molded at a pressure and temperature that is sufficiently low so as to not appreciably deform the first layer. The first layer is then molded at a different pressure or temperature. In one embodiment, both the first layer and the second layer are controllably displaced substantially simultaneously, with the softer second layer experiencing larger mechanical strains than the higher modulus first layer. As a result of the controllable displacement, the patterned second layer is no longer a contiguous or continuous material and may be completely expelled from depressions formed in the first layer.

The controllable displacement by embossing or molding is performed with a micropatterned or nanopatterned stamp structure. After the first layer and the second layer are embossed with the patterned stamp structure, the second layer and/or the first layer are cured or otherwise solidified. The layers can be cured by a thermal or electromagnetic radiation source, by cooling, or by drying, depending on the material. Generally, the layers are solidified while the stamp structure is in contact with the layers. The stamp structure is then removed from the layers in a demolding step. Release agents may be applied to the surface of the stamp structure or the molded layers to ensure smooth release of the stamp structure from the surface.

In one embodiment, the controllable displacement is solid forming including normal forces, shear forces, and/or a combination of normal forces and shear forces. In an alternative embodiment, the controllable displacement forms a liquid second layer and a solid first layer, wherein the controllable displacement first forms a liquid second layer and then forms a liquid first layer.

The patterned second layer may be made at least partially discontinuous by controllable displacement that completely expels the second layer from depressions formed in the first layer. The controllable displacement may sever the continuity between the top surface of the second layer and the remaining second layer in the depressions of the first layer. The second layer may be partially removed by etching, ablation, and/or decomposition. The patterning results in patterned exposed surfaces with different chemical functionality and/or different surface properties.

In one embodiment, the patterned multiple layer structure is subsequently treated to ensure the patterned second layer is not contiguous. In a particular embodiment, the second layer is chemically treated in a time-controlled etch or dissolution step to partially remove thin portions of the patterned second layer. Alternatively, the subsequent treatment can be performed from any number of suitable chemical, mechanical, and/or radiation treatments or a combination thereof.

In one embodiment, the patterned second layer includes a mask structure. A layer of third material can be coated and/or deposited through the non-contiguous areas of the second layer onto openings in the patterned first layer. The third material is deposited at least onto the unmasked regions of the first layer through the second layer mask structure, thereby coating the unmasked first layer.

In one embodiment, the third material includes a nanowire or nanoparticle solution or slurry including nanoparticles of metals, semiconductors, dielectrics, and/or catalyst particles. In alternative embodiments, the third material includes an organic semiconductor. In one embodiment, the third material is a liquid ink with one or more precursors including a metal and a solvent. The liquid ink may be a slurry. One or more precursors may be an organometallic complex or a nanoparticle. In one embodiment, the nanoparticle precursor includes a metal. The one or more precursors are a nanowire that is electrically conducting. The third material may be a liquid ink with one or more precursors that includes a semiconductor and a solvent. In this embodiment, the one or more precursors may be a nanoparticle precursor including a semiconductor. In one embodiment, the third material is a liquid ink including an organic semiconductor.

In one embodiment, the third material is a dielectric material. The dielectric material may be a spin on glass or polymer. Alternatively, the third material may be a liquid ink with one or more precursors including a dielectric and a solvent. The one or more precursors may be a nanoparticle, such as a titanium dioxide. The third material may be a liquid ink with one or more precursors including a catalyst. The one or more precursors may be a nanoparticle.

In further embodiments, the third material is then patterned to remove excess third material. Chemical, mechanical, or a combination of chemical and mechanical processing removes the third material from the second layer, resulting in a non-contiguous third layer. Such processing can result in the third material residing only over the unmasked regions of the first layer. The third material may be mechanically removed via a squeegee similar to screen printing or roll coating. The method may include curing or sintering the third layer and/or the removal of excess third material via etching or chemical mechanical polishing.

After the third material is coated and/or deposited, the third layer is solidified via drying or curing/sintering by thermal or electromagnetic radiation. The solidification step can add functionality to the third material. For example, curing the third material can create a solid film with high electrical conductivity.

In further embodiments, the second layer is selectively removed. The second layer can be thermally or chemically processed without affecting the first layer. For example, a chemical solvent can remove the second layer and any part of the third layer directly on top of the second layer in a “lift off” process. The processing of the second layer results in a non-contiguous third layer on the first layer.

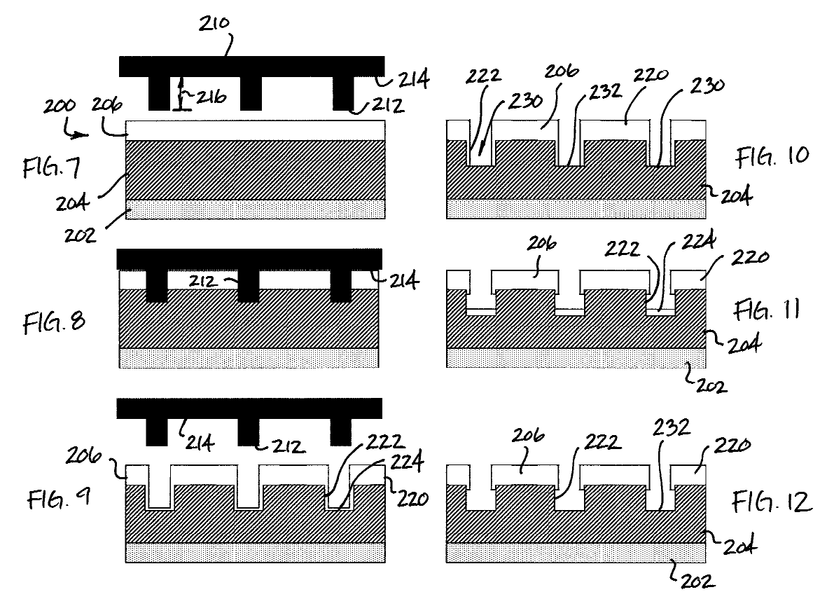

FIGS. 7-12 are cross-sectional views illustrating an exemplary method for forming a mask structure on at least a surface of a multi-layer material including a mechanically deformable first layer and a mechanically deformable second layer using a patterned stamp structure. Referring further to FIG. 7, a multi-layer material 200 includes a substrate 202 formed from one or more suitable materials including, without limitation, a silicon, metal, glass, quartz, ceramic, and/or polymer material. A first layer 204 of deformable material is deposited or coated onto a surface of substrate 202 and a second layer 206 of deformable material is deposited or coated onto a surface of first layer 204. In a particular embodiment, multi-layer structure 200 does not necessarily include substrate 202.

A stamp structure 210 is configured to emboss or mold first layer 204 and/or second layer 206. More specifically, stamp structure 210 includes a micropatterned or nanopatterned surface configured to controllably displace first layer 204 and/or second layer 206. In one embodiment, stamp structure 210 has a three-dimensional topography forming undulations or ridges and depressions having one or more raised regions 212 and one or more relatively lowered regions 214, shown schematically in FIGS. 7-9. In a particular embodiment, a distance 216 between raised region 212 and corresponding lowered region 214 is greater than a thickness of second layer 206. In the exemplary embodiment, stamp structure 210 is fabricated of a suitable metal material but, in alternative embodiments, may include any suitable material or combination of suitable materials including, without limitation, a polymer, silicon, and/or ceramic material. In a particular embodiment, second layer 206 and/or stamp structure 210 is coated with an interface layer (not shown) to reduce adhesion during a demolding process. Further, second layer 206 may be coated with an interface layer such that second layer 206 has a different chemical functionality and/or a different hydrophilicity or hydrophobicity than that of first layer 204. An interface layer with a desired chemical functionality and/or a desired hydrophilicity or hydrophobicity may also be coated on first layer 204 prior to deposition of second layer 206 on first layer 204.

FIG. 8 shows stamp structure 210 controllably displacing at least a portion of second layer 206 and a portion of first layer 204 via a suitable process including, without limitation, an embossing or molding process to form one or more voids through second layer 206. In the exemplary embodiment, second layer 206 and first layer 204 are embossed or molded during the same process. In alternative embodiments, second layer 206 is embossed or molded first without forming first layer 204. After second layer 206 is formed, first layer 204 is then embossed or molded. In a particular embodiment, second layer 206 has a lower modulus and/or a lower softening temperature than a respective modulus and/or softening temperature of first layer 204. Prior to removing stamp structure 210, first layer 204 and/or second layer 206 may be solidified by cooling, solvent evaporation, or applying thermal or electromagnetic radiation. In one embodiment, the embossing or molding process forms a discontinuous second layer 206. In an alternative embodiment, the embossing or molding process does not form a discontinuous second layer 206 but rather forms second layer 206 into a patterned mask structure 220, as shown in FIG. 9, with a continuous second layer 206 deposited on or applied to sidewalls 222 of first layer 204 and forming a thin residual portion 224 of second layer 206.

As shown in FIG. 10, in an alternative embodiment, the embossing or molding process results in discontinuous second layer 206. The embossing or molding process forms second layer 206 into patterned mask structure 220. During the embossing process, second layer 206 extends into a depression or lowered region formed in first layer 204 by corresponding raised region 212 of stamp structure 210. Second layer 206 is deposited on or applied to at least a portion of sidewalls 222 without forming residual portion 224 and, thus, a contiguous or continuous second layer 206. As shown in FIG. 10, no residual portion 224 is present and an unmasked structure 230 exposes and provides access to a surface 232 of first layer 204.

Referring to FIG. 11, in a further alternative embodiment, second layer 206 is made discontinuous by the embossing or molding process. The embossing or molding process forms second layer 206 into patterned mask structure 220. By embossing or molding into a portion of first layer 204, second layer 206 at or near sidewalls 222 no longer form a contiguous second layer 206 with residual portion 224. The embossing or molding process unmasks a portion of each sidewall 222, exposing first layer 204.

In a further embodiment, second layer 206 is made discontinuous by the embossing or molding process. FIG. 12 shows an alternative embossing or molding process, wherein second layer 206 is made discontinuous. The embossing or molding process forms second layer 206 into patterned mask structure 220. By embossing or molding into first layer 204, second layer 206 at or near sidewalls 222 no longer forms a contiguous or continuous layer and first layer 204 is exposed. The embossing or molding process unmasks a portion of sidewalls 222 and residual portion 224 to expose a portion of first layer 204.

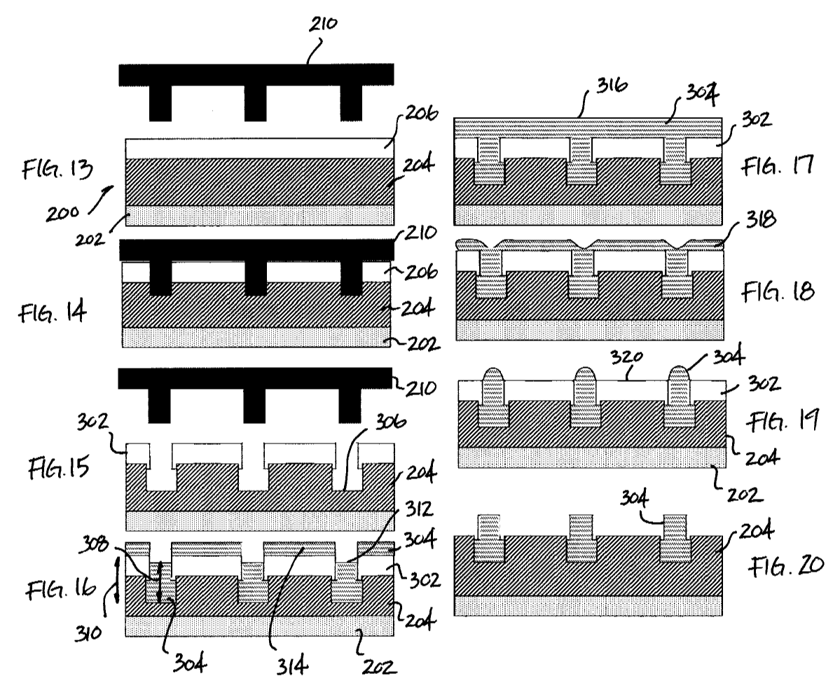

FIGS. 13-20 are cross-sectional views illustrating an exemplary method for forming a mask structure on at least a surface of a multi-layer material including a mechanically deformable first layer and a mechanically deformable second layer. Referring further to FIG. 13, multi-layer material 200 includes substrate 202. First layer 204 of deformable material is deposited or coated onto a surface of substrate 202 and second layer 206 of deformable material is deposited or coated onto a surface of first layer 204. Stamp structure 210 is configured to emboss or mold second layer 206, as described above in reference to FIGS. 7-12, to form a masked second layer 302, as shown in FIG. 15.

A third layer of material 304 is deposited or coated on masked second layer 302 using a suitable depositing or coating process including, without limitation, an ink jetting, spin-coating, casting, gravure printing, screen printing, roll coating, gap coating, rod coating, extrusion coating, dip coating, curtain coating, air knife coating, impact printing, stamping, roll-to-roll printing, and/or contact printing process. As part of the depositing or coating process, unmasked regions 306 of first layer 204, shown in FIG. 15, are covered with third layer 304. In one embodiment, as shown in FIG. 16, a thickness 308 of the deposited third layer 304 is less than a height 310 of the patterned features in first layer 204 and second layer 206. In a particular embodiment, third layer 304 is discontinuous after coating or deposition, as shown in FIG. 16.

Third layer 304 may be solidified after deposition by cooling, solvent evaporation, or applying thermal or electromagnetic radiation. The electromagnetic radiation may be transmitted through substrate 202 or via a top surface of multi-layer material 200. In one embodiment, an ultraviolet source generates sufficient electromagnetic radiation. In a particular embodiment, the ultraviolet radiation is transmitted through substrate 202 to selectively cure third layer 304. Masked second layer 302 is opaque to the electromagnetic radiation, resulting in a cured third layer 312 above unmasked regions 306 of first layer 204 and an uncured third layer 314 above masked second layer 302.

In alternative embodiments, third layer 304 is coated to have a planar surface 316, as shown in FIG. 17, or a conformal surface 318, as shown in FIG. 18. Alternatively, as shown in FIG. 19, third layer 304 can also partially adhere to only unmasked regions 306 of first layer 204 without adhering to a surface 320 of masked second layer 302. Masked second layer 302 may be removed chemically or thermally via a lift off process, resulting in patterned regions of third layer 304 on first layer 204, as shown in FIG. 20. In an alternative embodiment, masked second layer 302 remains a structural member and uncured third layer 314 is removed using a suitable chemical, thermal, or mechanical process.

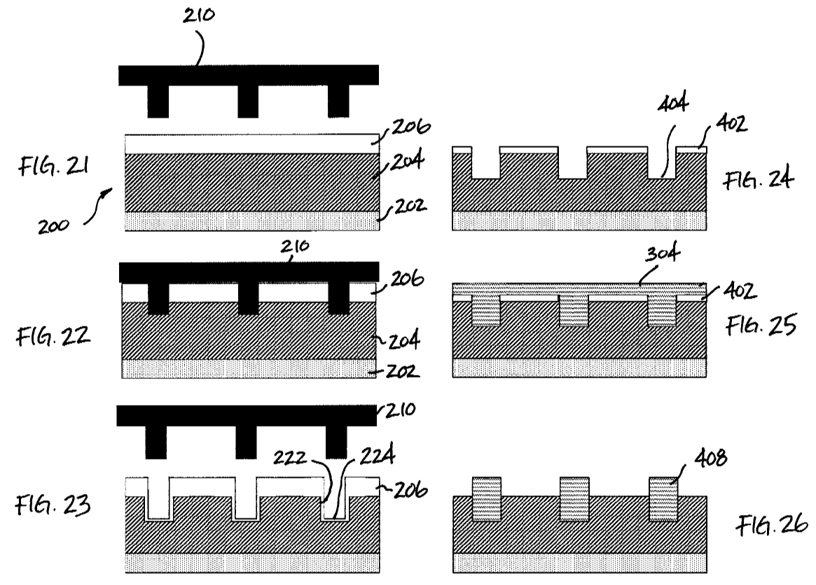

FIGS. 21-26 show an alternative embodiment for further processing second layer 206 patterned by embossing or molding prior to deposition of third layer 304. Referring further to FIG. 21, multi-layer material 200 includes substrate 202, first layer 204 of deformable material deposited or coated onto a surface of substrate 202, and second layer 206 of deformable material deposited or coated onto a surface of first layer 204. Stamp structure 210 is configured to emboss or mold second layer 206, as described above in reference to FIGS. 7-12.

FIG. 22 shows stamp structure 210 controllably displacing at least a portion of second layer 206 and a portion of first layer 204 via a suitable process including, without limitation, an embossing or molding process. In one embodiment, the embossing or molding process forms a continuous second layer 206 as patterned mask structure 220 with continuous second layer 206 deposited on or applied to sidewalls 222 of first layer 204 and forming thin residual portion 224 of second layer 206. Second layer 206 may be processed chemically or thermally in a rate controlled step to partially remove portions of second layer 206. The chemical or thermal processing results in a thin masked structure 402 of second layer 206 without a residual thin film of second layer material above depressed unmasked regions 404 of first layer 204. The chemical or thermal processing exposes unmasked regions 404 of first layer 204. Referring to FIG. 25, third layer of material 304 is then deposited as described above. As shown in FIG. 26, masked structure 402 is removed chemically or thermally via a lift off process, resulting in patterned regions 408 of third layer 304 on first layer 204.

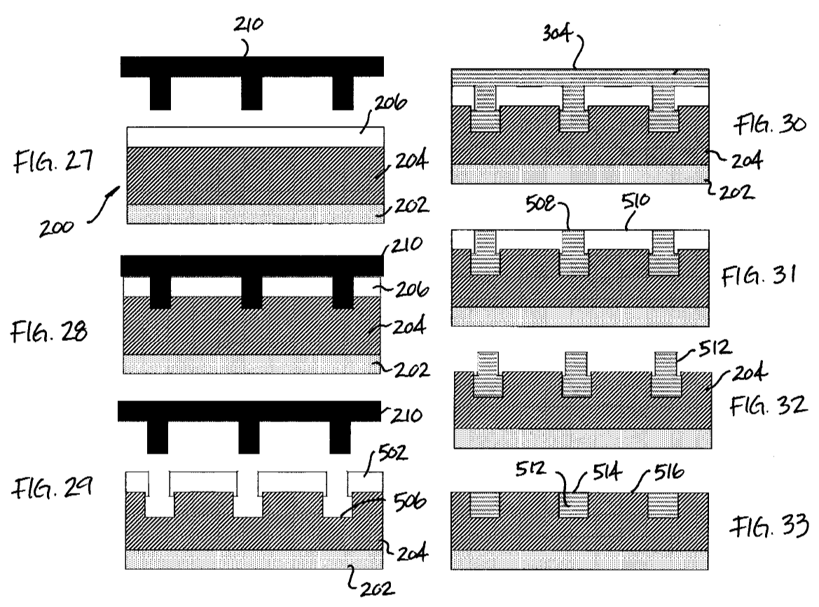

FIGS. 27-33 show an alternative embodiment for processing third layer 304 after coating and/or deposition. Referring further to FIG. 27, multi-layer material 200 includes substrate 202. First layer 204 of deformable material is deposited or coated onto a surface of substrate 202 and second layer 206 of deformable material is deposited or coated onto a surface of first layer 204. Stamp structure 210 is configured to emboss or mold second layer 206, as described above in reference to FIGS. 7-12, to form a masked second layer 502, as shown in FIG. 29.

Third layer 304 is deposited or coated on masked second layer 502 using a suitable depositing or coating process including, without limitation, an ink jetting, spin-coating, casting, gravure printing, screen printing, roll coating, gap coating, rod coating, extrusion coating, dip coating, curtain coating, air knife coating, impact printing, stamping, roll-to-roll printing, and/or contact printing process. As part of the depositing or coating process, unmasked regions 506 of first layer 204, shown in FIG. 29, are covered with third layer 304.

In one embodiment, third layer 304 is partially removed, as shown in FIG. 31, prior to or after curing via rate dependent a chemical processing, mechanical processing, or chemical mechanical polishing step. The processing results in a surface 508 of third layer 304 in plane with a surface 510 of masked second layer 502. Masked second layer 502 remains as a structural component or can be removed via a thermal or chemical process. A patterned third layer 512 on first layer 204 can then be further planarized via a rate dependent chemical processing, mechanical processing, or a chemical mechanical polishing step. Planarization results in a surface 514 of patterned third layer 512 in plane with a surface 516 of first layer 204, as shown in FIG. 33.

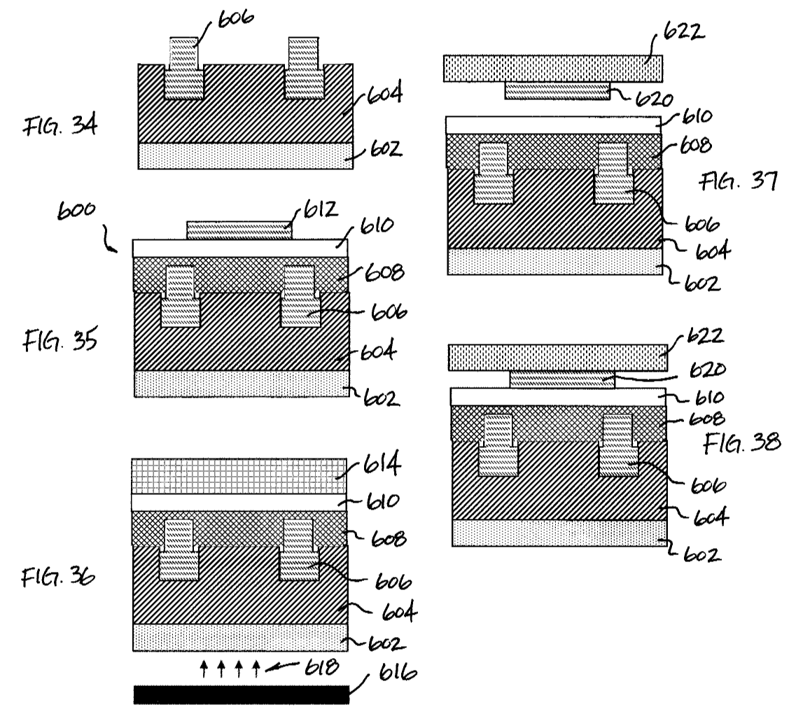

Referring to FIGS. 34-38, one or more methods described herein may be used to fabricate an exemplary thin-film transistor 600, as shown in FIG. 35. FIG. 34 shows a substrate 602 with a first layer of deformable material 604 and a patterned third layer of material 606. In one embodiment, third layer 606 is patterned using a suitable method such as described above in reference to FIGS. 7-33. In this embodiment, patterned third layer 606 includes an electrically conducting metal, such as Silver (Ag), Gold (Au), Copper (Cu), Cobalt (Co) or another suitable electrically conducting metal material. In a further embodiment, substrate 602 is a flexible material, such as a polymer or any suitable substrate that is transparent to ultraviolet radiation. FIG. 35 shows transistor 600 formed on patterned third layer 606. A semiconducting layer 608 is deposited on patterned third layer 606 and first layer 604. A dielectric layer 610 is deposited on semiconducting layer 608. Semiconducting layer 608 and/or dielectric layer 610 are deposited using any suitable coating and/or deposition process including, without limitation, an ink jetting, spin-coating, casting, gravure printing, screen printing, roll coating, gap coating, rod coating, extrusion coating, dip coating, curtain coating, air knife coating, impact printing, stamping, roll-to-roll printing, and/or contact printing process. Semiconducting layer 608 and/or dielectric layer 610 may form a planar coating or conformal coating on a respective surface. A patterned metal structure 612 is positioned on and/or coupled to on dielectric layer 610 to form transistor 600. Patterned metal structure 612 is deposited and patterned with one or more suitable processes including, without limitation, a lithography, ink jetting, spin-coating, casting, gravure printing, screen printing, roll coating, gap coating, rod coating, extrusion coating, dip coating, curtain coating, air knife coating, impact printing, stamping, roll-to-roll printing, and/or contact printing process.

In one embodiment, prepatterned metal structure 612 is formed by first depositing a film of photodefinable material 614 on dielectric layer 610, as shown in FIG. 36. A radiation source 616 emits radiation 618 that travels through substrate 602 and reacts with photodefinable material 614. Patterned third layer 606 functions as a self-aligned mask for photodefinable material 614. The reacted photodefinable material can then be selectively removed from the unreacted photodefinable material. In one embodiment, radiation source 616 is an ultraviolet radiation source that generates ultraviolet radiation. The patterned photodefinable material 614 is then used as a mask to deposit a conducting material including a metal, metallic precursor, or any suitable conducting or conducting precursor layer onto the unmasked dielectric layer 610. In a further embodiment, the conducting material is coated or deposited using any suitable deposition process including, without limitation, an ink jetting, spin-coating, casting, gravure printing, screen printing, roll coating, gap coating, rod coating, extrusion coating, dip coating, curtain coating, air knife coating, impact printing, stamping, roll-to-roll printing, and/or contact printing process. As part of the coating process, the unmasked regions of dielectric layer 610 are covered with the conducting material. In one embodiment, a thickness of the deposited conducting material is less than a thickness of photodefinable material 614. In a particular embodiment, the conducting layer is discontinuous after coating or deposition.

After deposition of the conducting layer, the conducting layer may be solidified by cooling, solvent evaporation, or applying thermal or electromagnetic radiation. The electromagnetic radiation can be transmitted through substrate 602 or via an opposing side of the structure. In one embodiment, the electromagnetic radiation is generated by an ultraviolet source. In this embodiment, ultraviolet radiation is transmitted through substrate 602 to selectively cure the conducting layer. The patterned third layer 606 functions as a self-aligned mask for photodefinable material 614. Photodefinable material 614 can be removed chemically or thermally via a lift off process, resulting in patterned regions of the conducting material on dielectric layer 610.

In a further embodiment, a conducting layer 620 is prepatterned on a structural layer 622, as shown in FIG. 37. In a particular embodiment, structural layer 622 is flexible. The prepatterned conducting layer 620 on structural layer 622 is then aligned and deposited or coated on dielectric layer 610 to form transistor 600. In this embodiment, the deposition process includes a lamination process. In a particular embodiment, structural layer 622 is removed via chemical, thermal, or any suitable processing step.

The embodiments described herein provide an alternative to photolithographic methods and vacuum processing for fabricating devices with features having dimensions less than about 25 microns. Methods as described herein provide the ability to directly emboss a patterned mask structure on a deformable material, which can be used in subsequent processing steps to pattern a subsequently deposited layer. The mask structures are then removed or remain as functional layers in a micro-fabricated device. These methods may be particularly useful for building electrical components in microelectronic devices. The embodiments described herein provide methods for forming an electronic device using liquid embossing and non-vacuum device fabrication methods to form layers of the electronic device.

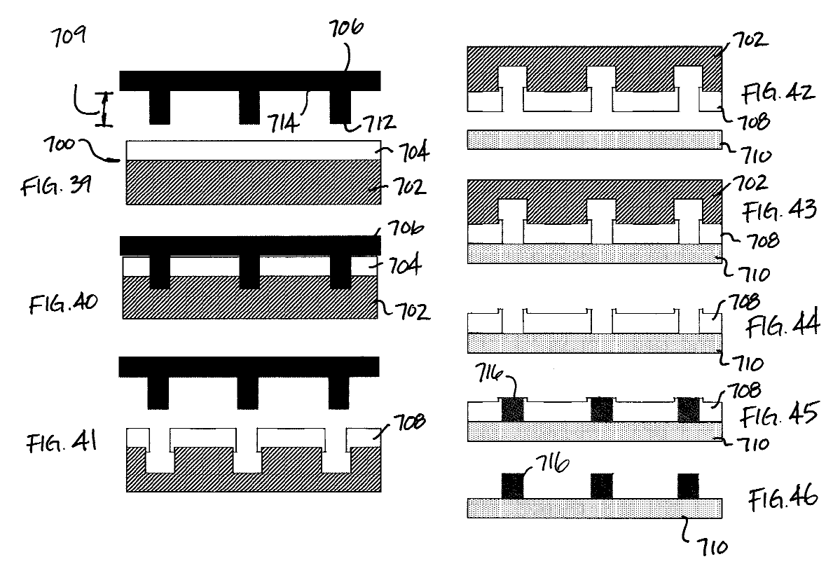

FIGS. 39-46 are cross-sectional views of an arbitrary material and show an exemplary method for creating a controlled topography on an arbitrary surface using a mask structure, herein described using a molding process. Alternative embodiments may pattern the mask structure with processes other than a molding process. Referring further to FIG. 39, a multi-layer material 700 includes a first layer 702 of deformable material and a second layer 704 of deformable material deposited or coated onto a surface of first layer 702. A stamp structure 706 is configured to mold second layer 704, such as described above in reference to FIGS. 7-12, to form a patterned mask structure 708, as shown in FIG. 41. Stamp structure 706 has three-dimensional topography with raised regions and lowered regions. In a particular embodiment, a distance 709 between a raised region 712 and a corresponding lowered region 714 is greater than a thickness of second layer 704. In this embodiment, stamp structure 706 is metal but, in alternative embodiments, stamp structure 706 is made of any suitable material including, without limitation, a polymer, silicon, ceramic, or any suitable material and combinations thereof. Stamp structure 706 and/or second layer 704 may be coated with an interface layer to reduce adhesion during demolding. Second layer 704 may be coated with an interface layer to create a chemical functionality and/or a hydrophilicity or a hydrophobicity different from that of first layer 702.

FIG. 40 shows stamp structure 706 controllably displacing via molding second layer 704 and first layer 702. In one embodiment, second layer 704 and first layer 702 are molded in the same process. In alternative embodiments, second layer 704 is molded first without forming first layer 702. After second layer 704 is formed, first layer 702 is then molded. In a particular embodiment, second layer 704 has a lower modulus and/or a lower softening temperature than a respective modulus and/or a softening temperature of first layer 702. Prior to removing stamp structure 706, first layer 702 and/or second layer 704 can be solidified by cooling, solvent evaporation, or applying thermal or electromagnetic radiation. In this embodiment, the embossing or molding process forms a discontinuous second layer 704. FIG. 41 shows stamp structure 706 removed from first layer 702 and second layer 704 after controllably displacing first layer 702 and second layer 704. The process forms patterned mask structure 708 from second layer 704.

FIG. 42 shows attachment of patterned mask structure 708 onto a third layer of material 710. In this embodiment, third layer 710 includes a metal material but, alternatively, may include a polymer, silicon, ceramic, or any suitable material and combinations thereof. In one embodiment, third layer 710 is coated with a thin layer of metal to act as a seed layer for electroplating. In one embodiment, patterned mask structure 708 is coated with an adhesive layer prior to contacting third layer 710. FIG. 43 shows patterned mask structure 708 coupled to third layer 710. FIG. 44 shows removal of first layer 702, resulting in access to third layer 710 through patterned mask structure 708. In this embodiment, first layer 702 is selectively removed via a chemical wet etch that does not modify second layer 704 or third layer 710. As shown in FIG. 44, patterned mask structure 708 remains as a controlled topography on an arbitrary surface of third layer 710. Patterned mask structure 708 may be post-processed chemically, thermally, or via ultraviolet radiation to change the functionality of patterned mask structure 708. FIG. 45 shows an additional material 716 deposited through patterned mask structure 708 onto third layer 710. In one embodiment, material 716 is deposited via electroplating. FIG. 46 shows patterned mask structure 708 removed, such as via a chemical wet etch process that does not modify third layer 710 or material 716. The resulting structure is an arbitrary surface with controlled topography including the same metal material such that the arbitrary surface with controlled topography is a metal mold useful for embossing or molding curved surfaces or planar surfaces in a roll-to-roll manufacturing process.

This written description uses examples to disclose the invention, including the best mode, and also to enable any person skilled in the art to practice the invention, including making and using any devices or systems and performing any incorporated methods. The patentable scope of the invention is defined by the claims, and may include other examples that occur to those skilled in the art. Such other examples are intended to be within the scope of the claims if they have structural elements that do not differ from the literal language of the claims, or if they include equivalent structural elements with insubstantial differences from the literal language of the claims.

What is claimed is:

1. A method for patterning a surface comprising:
providing a first layer of mechanically deformable material having a first surface;
placing a second layer of mechanically deformable material on the first surface; and
controllably displacing at least a portion of the second layer to form at least one patterned void through the second layer.

2. A method in accordance with claim 1 further comprising controllably displacing a portion of the first layer to form the at least one patterned void.

3. A method in accordance with claim 1 further comprising depositing an interfacial layer between the first layer and the second layer.

4. A method in accordance with claim 1 further comprising depositing an interfacial layer on at least one of the first layer and the second layer.

5. A method in accordance with claim 4 wherein the at least one patterned void is formed through the second layer prior to depositing the interfacial layer.

6. A method in accordance with claim 1 further comprising depositing the first layer on a non-deformable substrate.

7. A method in accordance with claim 1 wherein controllably displacing at least a portion of the second layer comprises a solid forming.

8. A method in accordance with claim 7 wherein the solid forming comprises applying one of a normal force, a shear force, and a combination thereof.

9. A method in accordance with claim 1 wherein controllably displacing at least a portion of the second layer comprises forming a liquid second layer and a solid first layer.

10. A method in accordance with claim 1 wherein controllably displacing at least a portion of the second layer comprises forming a discontinuous second layer.

11. A method in accordance with claim 1 wherein a portion of the second layer is controllably displaced from within a corresponding depression formed in the first layer.

12. A method in accordance with claim 11 wherein controllably displacing at least a portion of the second layer forms a top surface of the second layer separated from the portion of the second layer in the corresponding depression.

13. A method in accordance with claim 1 wherein controllably displacing at least a portion of the second layer comprises partially removing the second layer using one of an etching, an ablation, and a decomposition process.

14. A method in accordance with claim 1 wherein controllably displacing at least a portion of the second layer comprises forming a plurality of exposed surfaces having at least one of a different chemical functionality and a different surface property.

15. A method in accordance with claim 1 further comprising depositing a third layer of material onto the first layer through the at least one patterned void.

16. A method in accordance with claim 15 wherein a liquid ink having at least one precursor comprising at least one of a metal and a solvent, a semiconductor and a solvent, an organic semiconductor, a dielectric and a solvent, and a catalyst is deposited onto the first layer through the at least one patterned void.

17. A method in accordance with claim 15 further comprising removing a portion of the third layer.

18. A method in accordance with claim 15 further comprising one of curing and sintering the third layer.

19. A method in accordance with claim 15 further comprising depositing at least one additional layer of material on the third layer.

20. A method in accordance with claim 19 wherein depositing at least one additional layer of material on the third layer comprises:
depositing a semiconductor layer on the third layer;
depositing a dielectric layer on the semiconductor layer; and
depositing a metal layer on the dielectric layer.

21. A method in accordance with claim 1 wherein a stamp structure having at least one raised surface that defines a patterned feature controllably displaces at least a portion of the second layer.

22. A method in accordance with claim 1 wherein controllably displacing at least a portion of the second layer comprises one of an ink jetting, spin-coating, casting, lithography, gravure printing, screen printing, roll coating, gap coating, rod coating, extrusion coating, dip coating, curtain coating, air knife coating, impact printing, stamping, roll-to-roll printing, and contact printing process.

23. A method for making a mold structure having a controlled topography, said method comprising:
providing a first layer of polymeric material;
depositing a second layer of polymeric material on a first surface of the first layer;
patterning at least one of the first layer and the second layer to form a mask structure;
attaching the mask structure to a third layer of material, the second layer contacting the third layer;
removing the first layer such that the mask structure provides access to the third layer;
depositing a fourth layer of material on the mask structure; and
removing the second layer such that the fourth layer has a surface having a controlled topography.

24. A method in accordance with claim 23 attaching the mask structure to a third layer of material comprises attaching the mask structure to one of a curved third layer and a flexible third layer.

25. A method in accordance with claim 23 wherein the at least one of the first layer and the second layer is patterned using one of a molding, embossing, laser writing, lithography, wet or dry chemical etching process and combinations thereof.

26. A method in accordance with claim 23 further comprising selectively removing at least one of the first layer and the second layer without altering other layers.

27. A method in accordance with claim 23 wherein the at least one of the first layer and the second layer is patterned in multiple steps.

28. A method in accordance with claim 23 further comprising depositing a metal layer on the third layer.

29. A method in accordance with claim 23 wherein the fourth layer of material is deposited on the mask structure using one of an electroplating, ink jetting, spin-coating, casting, lithography, gravure printing, screen printing, roll coating, gap coating, rod coating, extrusion coating, dip coating, curtain coating, air knife coating, impact printing, stamping, roll-to-roll printing, and contact printing process.

30. A method in accordance with claim 23 further comprising patterning the second layer with an adhesive agent via contact printing prior to attaching the mask structure to the third layer.

31. A method in accordance with claim 23 wherein the controlled topography is created on at least one of an external surface and an internal surface of a tubular mold structure.

32. A method in accordance with claim 23 wherein the second layer forms the controlled topography on the mold structure.
